(19) United States
(12) Patent Application Publication
(10) Pub. No.: US 2024/0357549 A1
(43) Pub. Date: Oct. 24, 2024

(54) INTEGRITY OF POSITIONING TECHNIQUES THAT DEPEND ON RADIO ACCESS

(71) Applicant: ZTE Corporation, Shenzhen (CN)

(72) Inventors: Junpeng LOU, Shenzhen (CN); Chuangxin JIANG, Shenzhen (CN); Yu PAN, Shenzhen (CN); Di ZONG, Shenzhen (CN); Mengzhen LI, Shenzhen (CN); Focai PENG, Shenzhen (CN)

(21) Appl. No.: 18/759,685

(22) Filed: Jun. 28, 2024

Related U.S. Application Data
(63) Continuation of application No. PCT/CN2022/122946, filed on Sep. 29, 2022.

(51) Int. Cl. H04W 64/00; H04W 24/10

(52) U.S. Cl. CPC H04W 64/006; H04W 24/10

(57) ABSTRACT

Positioning integrity is a measure of the trust in the accuracy of position-related data provided by a positioning system. Disclosed is a method of wireless communication including receiving, at a network node, one or more location measurement results, wherein each location measurement result includes a corresponding position estimate of a wireless device, and receiving, at the network node, a corresponding assistance data for each of the plurality of location measurement results; determining, at the network node, from the one or more location measurement results and the corresponding assistance information, a first distribution of the one or more location measurement results information and a second distribution of the corresponding assistance information, wherein an error source determines in part the first distribution or the second distribution; and determining, at a network node, from the first distribution and the second distribution, an integrity value of a position of the wireless device.

### CROSS-REFERENCE TO RELATED APPLICATIONS

This application is a continuation of International Patent Application No. PCT/CN2022/122946, filed on Sep. 29, 2022, the contents of which are incorporated herein by reference in their entirety.

### TECHNICAL FIELD

This patent document is directed to wireless communications.

### BACKGROUND

In some wireless technologies including 5G new radio (NR), wireless device location is needed but location information is rarely precise. Various sources of error can reduce the accuracy of location information. New techniques are needed to evaluate these errors and their importance to system operation.

### SUMMARY

Positioning integrity is a measure of the trust in the accuracy of position-related data provided by a positioning system. Disclosed are techniques for increasing the accuracy of integrity determinations using more than one measurement for timing-based positioning method and angle-based positioning. These multiple measurements can be described statistically and decisions about integrity made based on the statistics.

In one aspect, a method of wireless communication is disclosed. The method includes receiving, at a network node, one or more location measurement results, wherein each location measurement result includes a corresponding position estimate of a wireless device, and receiving, at the network node, a corresponding assistance data for each of the plurality of location measurement results. The method also includes determining, at the network node, from the one or more location measurement results and the corresponding assistance information, a first distribution of the one or more location measurement results information and a second distribution of the corresponding assistance information, wherein an error source determines in part the first distribution or the second distribution. The method further includes determining, at a network node, from the first distribution and the second distribution, an integrity value of a position of the wireless device.

In another aspect, another method of wireless communication is disclosed. The method includes receiving, at a wireless node, one or more location measurement results, wherein each location measurement result includes a corresponding position estimate of the wireless device, and receiving, at the wireless device, a corresponding assistance data for each of the plurality of location measurement results. The method includes determining, at the wireless device, from the one or more location measurement results and the corresponding assistance information, a first distribution of the one or more location measurement results information and a second distribution of the corresponding assistance information, wherein an error source determines in part the first distribution or the second distribution. The method further includes determining, at a wireless device, from the first distribution and the second distribution, an integrity value of a position of the wireless device.

### BRIEF DESCRIPTION OF THE DRAWINGS

FIG. 1 depicts an example of information exchange for determining the integrity of position or location information;

FIG. 2 depicts an example of a process performed at a network node;

FIG. 3 depicts an example of a process performed at a wireless device;

FIG. 4 depicts an example of a system, in accordance with some example embodiments; and

FIG. 5 depicts an example of an apparatus, in accordance with some example embodiments.

### DETAILED DESCRIPTION

Positioning integrity is a measure of the trust in the accuracy of position-related data provided by a positioning system. Systems that monitor position integrity should provide timely warnings if the integrity of the positioning system position estimates fall below a threshold. Disclosed are techniques and systems for identifying and quantifying error sources in radio access technology dependent positioning systems including techniques for increasing the accuracy of integrity determinations using more than one measurement for timing-based positioning method and angle based positioning. These multiple measurements can be described statistically and decisions about integrity made based on the statistics.

Positioning integrity can be applied to GNSS positioning methods and assisted-GNSS positioning methods. Positioning integrity provides a method to evaluate the trustworthiness of the position estimates. Previous work has been limited to radio access technology (RAT) independent positioning methods. Disclosed are techniques that can be extended to RAT dependent positioning methods including identifying error sources to positioning and modelling these error sources statistically to enable integrity decisions based on the statistical representation of the error sources.

Disclosed are techniques for improving the accuracy of integrity determination. These techniques can include using more than one measurement for timing-based positioning and angle-based positioning. Disclosed are methods for obtaining the mean and standard or the bound of one or more error sources. Parameters such as BeamInfo, BeamAntennaInfo, timing error group (TEG) and TEG margin are also detailed below.

Positioning Integrity is a measure of the trust in the accuracy of the position-related data provided by the positioning system and the ability to provide timely and valid warnings to the location services (LCS) client when the positioning system does not meet one or more conditions for proper operation.

For statistical evaluation, PL is defined for measuring the real-time upper bound of the positioning error at the required degree of confidence, where the degree of confidence is determined by the TIR probability. It satisfies the following inequality:

$$( EQ . 1 )$$

$$Prob per unit of time [ ( ( PE > AL ) \& ( PL <= AL ) ) for longer than TTA ] < required TIR$$

NOTE: When the PL bounds the positioning error in the horizontal plane or on the vertical axis then it is called Horizontal Protection Level (HPL) or Vertical Protection Level (VPL) respectively.

NOTE: A specific equation for the PL is not specified as this is implementation-defined. For the PL to be considered valid, it must simply satisfy the inequality above.

Using the global navigation satellite system (GNSS) positioning method, according to the inequality above, the network will ensure that:

$$( EQ . 2 )$$

$$P ( Error > Bound for longer than TTA \vert NOT DNU ) <= Residual Risk + IRallocation$$

for all values of IRallocation in the range irMinimum<=IRallocation<=irMaximum, where the following apply.

Error: Error is the difference between the true value of a GNSS parameter (e.g., ionosphere, troposphere, etc.), and its value as estimated and provided in the corresponding assistance data

Bound: Integrity Bounds provide the statistical distribution of the residual errors associated with the GNSS positioning corrections (e.g., RTK, SSR, etc.). Integrity bounds are used to statistically bound the residual errors after the positioning corrections have been applied. The bound is computed according to the bound formula. The bound formula describes a bounding model including a mean and standard deviation (e.g., paired over-bounding Gaussian). The bound may be scaled by multiplying the standard deviation by a K factor corresponding to an IRallocation, for any desired IRallocation within the permitted range.

Bound for a particular error is computed according to the following formula:

$$Bound = mean + K * stdDev \qquad ( EQ . 3 )$$

$$K = normInv ( {IR}_{allocation} / 2 )$$

$$irMinimum <= {IR}_{allocation} <= irMaximum$$

where: mean: mean value for this specific error

stdDev: standard deviation for this specific error. The following apply:

Time-to-Alert (TTA): The maximum allowable elapsed time from when the Error exceeds the Bound until a DNU flag must be issued.

DNU: The DNU flag(s) corresponding to a particular error as. Where multiple DNU flags are specified, the DNU condition in Equation 2.2 is present when any of the flags are true (logical OR of the flags).

Residual Risk: The residual risk is the component of the integrity risk provided in the assistance data. This may correspond to the fault case risk but the implementation is permitted to allocate this component in any way that satisfies EQ. 2.

The Residual Risk is the Probability of Onset which is defined per unit of time and represents the probability that the feared event begins. Each Residual Risk is accompanied by a Mean Duration which represents the expected mean duration of the corresponding feared event and is used to convert the Probability of Onset to a probability that the feared event is present at any given time, i.e.

$$( EQ . 4 )$$

$$P ( Feared Event is Present ) = Mean Duration * Probability of Onset of Feared Event$$

irMinimum, irMaximum: Minimum and maximum allowable values of IRallocation that may be chosen by the client. Provided as service parameters from the Network according to Integrity Service Parameters.

Correlation Times: The minimum time interval beyond which two sets of GNSS assistance data parameters for a given error can be considered to be independent from one another.

NR-TimingQuality: This field specifies the target device's best estimate of the quality of the TOA measurement. Note, the TOA measurement refers to the TOA of this neighbour TRP or the reference TRP, as applicable, used to determine the nr-RSTD or nr-RSTD-ResultDiff. The IE NR-TimingQuality defines the quality of a timing value (e.g., of a TOA measurement).

timingQualityValue: This field provides an estimate of uncertainty of the timing value for which the IE NR-TimingQuality is provided in units of metres.

timingQualityResolution: This field provides the resolution used in the timingQualityValue field. Enumerated values mdot1, m1, m10, m30 correspond to 0.1, 1, 10, 30 metres, respectively.

See the following pseudocode:

| -- ASN1START | |
|---|---|
| NR-TimingQuality-r16 ::= SEQUENCE { | |
| timingQualityValue-r16 | INTEGER (0..31), |

```
  timingQualityResolution-r16 ENUMERATED
  {mdot1, m1, m10, m30, ...},
  ...
}
-- ASN1STOP
```

### EXAMPLE EMBODIMENTS

### Example 1

The statistical properties of the measurement results are applied to the parameters related to positioning integrity. A single measurement is the measurement result obtained at a time stamp or for a certain TRP. Considering the adequacy of statistical, the measurement samples obtained cannot fully reflect the distribution of relevant error sources. So the bound or the mean and standard deviation of the distribution obtained from these samples is not representative.

Therefore, the relationship between multiple measurement results and location integrity parameters should be introduced.

For measurements of target device in Rel-17, The IE Provide LocationInformation is used by the target device to provide location measurements to the location server. The structure is that one ProvideLocationInformation IE contains some SignalMeasurementInstances, and one SignalMeasurementInstances IE has some SignalMeasurementInformation IEs. The SignalMeasurementInformation includes some measurement results which could be used for integrity, such as NR-TimingQuality, RSTD, RTOA, Rx−Tx time difference IEs, etc.

To obtain the parameters of error source distribution by statistical method, it could be per SignalMeasurementInformation or per SignalMeasurementInstances or per Provide LocationInformation or per some Provide LocationInformations.

### Example 2

The relations among error sources and the relations between error sources and measurements are mainly introduced as following.

To consider the integrity for RAT dependent positioning, for time-based positioning methods or positioning methods that utilize time-dependent measurements, such as the IE NR-RTD-Info is used by the location server to provide time synchronization information between a reference TRP and a list of neighbour TRPs. The rtd-Quality of IE NR-RTD-Infosynchronization specifies the quality of the RTD.

The following error sources mostly as measurements which are related with TOA.
RSTD measurement is an error source for DL-TDOA.
RTOA measurement is an error source for UL-TDOA.
UE Rx−Tx time difference measurement is an error source for Multi-RTT
gNB Rx−Tx time difference measurement is an error source for Multi-RTT.
the IE NR-RTD-Info or the rtd-Quality of IE NR-RTD-Info
NR-TimingQuality IE.

Most of the above and some other error source following are also related with NR-TimingQuality IE. As mentioned in TS 37.355:

| | |
|---|---|
| nr-PathQuality-r16 | NR-TimingQuality-r16 |
| rtd-RefQuality-r16 | NR-TimingQuality-r16 |
| rtd-Quality-r16 | NR-TimingQuality-r16, |
| nr-TimingQuality-r16 | NR-TimingQuality-r16, |

Related to the follow positioning method or IEs:
NR-DL-TDOA
NR-Multi-RTT
NR-RTD-Info (involved in NR DL-AoD and NR-DL-TDOA Positioning)
NR-AdditionalPathList

### Scheme 1:

For these error source based on timing, when the measurements of these error source should also with an IE NR-TimingQuality, there is no limit for the name of IE, just as rtd-Quality is ok for NR-RTD-Info. In order to obtain the mean and standard deviation or bound for these error source based on NR-TimingQuality.

### Scheme 2:

For these error source based on timing, they are separate error source for IE NR-TimingQuality. To obtain the mean and standard deviation or bound for these error source based on their own measurements. The NR-TimingQuality is also an separated error source.

For these error source mentioned above in Embodiment #2, they could be modeled Gaussian distribution with the parameters mean and the standard deviation or variance.

They could be modeled Truncated Gaussian distribution with the parameters mean and the standard deviation or variance. The distribution is associated with TOA error range, the bounds could be 0 to the requirement for a scenario.

### Embodiment #3

To illustrate the relation between measurements and the parameters of error source distribution. Following takes the IE NR-TimingQuality as an example, the schemes are also available for other sources:
Scheme 1: To obtain the parameters of error source distribution using a SignalMeasurementInformation measurements results.
Scheme 2: To obtain the parameters of error source distribution using a SignalMeasurementInstances measurements results.
Scheme 3: To obtain the parameters of error source distribution using a Provide LocationInformation measurements results.
Scheme 4: To obtain the parameters of error source distribution using m times Provide LocationInformation measurements results. And the value of m can be configured by the higher layer, or m is related to the measurement gap.

To the conclusion, to obtain the parameters of error source distribution by statistical method, scheme 1 is per SignalMeasurementInformation, scheme 2 is per SignalMeasurementInstances, scheme 3 is per ProvideLocationInformation, and scheme 4 is per some ProvideLocationInformations.

### Measurement Statistics Values

Based on one of the above schemes, some measurement results as a data set could be get. The parameters of error source distribution is further related with one value, and the value could be a IE to report, for example, using the value update the IE NR-TimingQuality.

The methods to get the measurement statistics values related with the parameters of error source distribution:
Scheme 1: Take the max value of the measurement data set as the value. It could be more valuable to describe the bound of error source distribution;
Scheme 2: Take the mean value of the measurement data set as the value;
Scheme 3: Take the mode value of the measurement data set as the value;
Scheme 4: Take the median value of the measurement data set as the value;
Scheme 5: Take the min value of the measurement data set as the value;
Scheme 6: Take one of the measurement data set value as the value; (per measurement)
Scheme 7: Take the standard deviation or variance of the measurement data set as the value;

### Relation Between Measurement Statistics Values and Distribution Parameters

The relation between the measurement statistics values and the parameters of error source distribution:

Case1: The measurement is aim to get the parameters for other error source for integrity.

For example, using the IE NR-TimingQuality to obtain the parameters for Rx−Tx time error distribution. Based on the measurement statistics values and the Gaussian distribution of Rx−Tx time error source, the mean value could be zero or the statistics from measurement, and the standard deviation could be obtain referencing the 3-sigma rule of Gaussian distribution.

Case2: the measurement is an error source for integrity.

Based on the measurement statistics values and the Gaussian distribution of the measurement error source, the mean and the standard deviation value could be obtain referencing measurement statistics value.

For case 1 and case 2:

Mean value: one of Scheme form 1 to 7 or related with Scheme form 1 to 7 or given form higher layer.

Standard deviation: one of Scheme form 1 to 7 or related with Scheme form 1 to 7 or given form higher layer.

For example:
Standard deviation: [½*quality] or [⅓*quality] or [¼*quality]
Bound: [−½*quality,−½*quality]
Where Quality value is one of above Scheme form 1 to 7.

### Range Relation of Error Source or Measurement Statistics Values or Distribution Parameters

For RSTD measurement, based on the Gaussian distribution, the mean of the distribution has relation with 0 or the expectedRSTD, and the standard deviation has relation with expectedRSTD-uncertainty.

In addition, other error sources also have the same relations. If no expectedErrorSource or expectedErrorSource-uncertainty, they should be introduced, such as RTOA, Rx−Tx time difference, NR-RTD-Info, rtd-Quality, NR-TimingQuality and other error source. And based on the Gaussian distribution, the mean of the error source distribution has relation with the expectedErrorSource, and the standard deviation has relation with expectedErrorSource-uncertainty. The relation could be the distribution parameters are smaller than the expectedErrorSource both for mean and standard deviation.

### Example 4

The same as Embodiment #3, for timing-based positioning methods NR-TimingQuality is an important measurement IE. For angle-based positioning methods, a measurement IE relevant integrity error source is also necessary.

Scheme 1: NR-AngleQuality should be introduced to measurement for integrity error source.

Scheme 2: NR-TimingQuality should be reused for angle-based positioning method, it could be transform to angle quality based on relevant measurement.

Considering the above two different schemes, AngleQuality is taken as the name of the measurement IE of angle. The measurement for integrity error source should be used for AOA and/or AOD positioning methods.

Following NR DL-AoD is taken as an example to explain.

And the measurement IE structure is same as the mentions in Embodiment #1. The IE NR-DL-AoD-ProvideLocationInformation is used by the target device to provide NR DL-AoD location measurements to the location server.

To illustrate the relation between measurements and the parameters of error source distribution. Following takes the IE AngleQuality as an example, the schemes are also available for other sources:
Scheme 1: To obtain the parameters of error source distribution using a SignalMeasurementInformation measurements results.
Scheme 2: To obtain the parameters of error source distribution using a SignalMeasurementInstances measurements results.
Scheme 3: To obtain the parameters of error source distribution using a Provide LocationInformation measurements results.
Scheme 4: To obtain the parameters of error source distribution using m times Provide LocationInformation measurements results. And the value of m can be configured by the higher layer, or m is related to the measurement gap.

To the conclusion, to obtain the parameters of error source distribution by statistical method, scheme 1 is per SignalMeasurementInformation, scheme 2 is per SignalMeasurementInstances, scheme 3 is per ProvideLocationInformation, and scheme 4 is per some ProvideLocationInformations.

### Measurement Statistics Values

Based on one of the above schemes, some measurement results as a data set could be get. The parameters of error source distribution is further related with one value, and the value could be a IE to report, for example, using the value update the IE AngleQuality.

The methods to get the measurement statistics values related with the parameters of error source distribution:
Scheme 1: Take the max value of the measurement data set as the value. It could be more valuable to describe the bound of error source distribution;
Scheme 2: Take the mean value of the measurement data set as the value;
Scheme 3: Take the mode value of the measurement data set as the value;
Scheme 4: Take the median value of the measurement data set as the value;
Scheme 5: Take the min value of the measurement data set as the value;
Scheme 6: Take one of the measurement data set value as the value; (per measurement)
Scheme 7: Take the standard deviation or variance of the measurement data set as the value;

### Relation Between Measurement Statistics Values and Distribution Parameters

The relation between the measurement statistics values and the parameters of error source distribution:

Case1: The measurement is aim to get the parameters for other error source for integrity.

For example, using the IE AngleQuality to obtain the parameters for AOA error distribution. Based on the measurement statistics values and the Gaussian distribution of AOA error source, the mean value could be zero or the statistics from measurement, and the standard deviation could be obtain referencing the 3-sigma rule of Gaussian distribution.

Case2: the measurement is an error source for integrity.

Based on the measurement statistics values and the Gaussian distribution of the measurement error source, the mean and the standard deviation value could be obtain referencing measurement statistics value.

For case 1 and case 2:

Mean value: one of Scheme form 1 to 7 or related with Scheme form 1 to 7 or given form higher layer.

Standard deviation: one of Scheme form 1 to 7 or related with Scheme form 1 to 7 or given form higher layer.

For example:
Standard deviation: [½*quality] or [⅓*quality] or [¼*quality]
Bound: [-½*quality,-½*quality]
Where quality value is one of above Scheme form 1 to 7.

### Range Relation of Error Source or Measurement Statistics Values or Distribution Parameters

For UL AOA positioning method, the expected uplink Angle of Arrival and uncertainty range in UL-AoA assistance information have relation with the AngleQuality measurement. Based on the Gaussian distribution of some angle error source, the mean of the distribution has relation with the Expected Azimuth/Zenith AoA Value, and the standard deviation has relation with Expected Azimuth/Zenith AoA Uncertainty Range.

In addition, other angle error sources which are measured also have the same relations. If no expectedErrorSource or expectedErrorSource-uncertainty, they should be introduced, such as AOA, ZOA, AOD, ZOD and other error source. And based on the Gaussian distribution or Truncated Gaussian distribution, the mean of the error source distribution has relation with the expectedErrorSource, and the standard deviation has relation with expectedErrorSource-uncertainty. The bound or bounds of Truncated Gaussian distribution are also related with expectedErrorSource and/or expectedErrorSource-uncertainty.

The relation could be the distribution parameters are smaller than the expectedErrorSource both for mean and standard deviation.

### Example 5

For IE nr-TRP-BeamAntennaInfo, this field provides the relative DL-PRS Resource power between PRS resources per angle per TRP. It should be as an error source or associated with an error source for integrity.

Case 1: The IE nr-TRP-BeamAntennaInfo-r17 associated error source should be modeled as Truncated Gaussian distribution.

Case 2: The IE nr-TRP-BeamAntennaInfo-r17 associated error source should be modeled as Gaussian distribution.

### Subcase 1:

For IE nr-TRP-BeamAntennaInfo, a value to measurement the efficiency of beam antenna information, it could be the difference or ratio between the first elements and others in relative power list. For the TRP-BeamAntennaInfo, the difference between the first and other elements is the bigger the better.

For example, if there are eight beams to transport, and the ideal beam direction interval is 360/8, it could be minimum the antenna interference. The differences or ratios between the first elements and others in relative power list would be max. But if the beam direction interval is small, the value to measurement efficiency of beam antenna would be small, it means the antenna interference is more serious.

For the model of error source, the distribution parameters (including bound or bounds, mean,std, etc.) are related with the beamPowerList IE and/or other sub-IEs of nr-TRP-BeamAntennaInfo. In addition, the distribution parameters are related with the number of transporting beams. And they could as a measurement result to using the same ways mentioned above embodiments.

### Subcase 2:

The minimum granularity of the direction is 0.1 degree in the IE nr-TRP-BeamAntennaInfo-r17. When the distance between target device and TRP is far, it would bring large errors even if the granularity 0.1 degree. This IE is related to an integrity error source to measure the accuracy of the direction of the line of sight;

In other words, the assistance data to target device only could distinguish 0.1 degree, it could result some errors. Following NR DL-AoD is taken as an example to explain, it also suitable for some other positioning methods.

For this error source, two schemes are giving for measurements based NR DL-AoD as an example:
Scheme 1: NR-BeamQuality should be introduced to measurement for integrity error source.
Scheme 2: nr-DL-PRS-RxBeamIndex should be reused for NR DL-AoD positioning method, it could be transform to beam quality based on relevant measurement.
nr-DL-PRS-RxBeamIndex-r16 INTEGER (1..8)

And the measurement IE structure is same as the mentions in Embodiment #1. The IE NR-DL-AoD-ProvideLocationInformation is used by the target device to provide NR DL-AoD location measurements to the location server.

To illustrate the relation between measurements and the parameters of error source distribution. Following takes the IE BeamQuality as an example, the schemes are also available for other sources. Schemes for BeamQuality are also like AngleQuality-based schemes in Embodiment #4.

In addition to the above schemes, the distribution parameters could be related to nr-DL-PRS-RxBeamIndex and the interval and/or the number/angle of transporting beams.

nr-DL-PRS-BeamInfo-r16 is an error source which should be modeled as Gaussian distribution or Truncated Gaussian distribution.

The IE nr-DL-PRS-BeamInfo-r16 is same as the Comprehension 2 above.

### Example 6

Timing error margins is giving by RAN4, and it should be measured and reported to LMF or other entity.

Following to take Rx TEG as an example to explain, the schemes are also suitable for UE Rx TEG, UE RxTx TEG, UE Tx TEG and so on.

Case 1: Timing error margins is an error source.

The error source should be modeled Gaussian distribution or Truncated Gaussian distribution. And the parameters could be given by PRU. The parameters as IEs could transfer from PRU/gNB to LMF and/or from LMF to gNB.

The parameters (including bound or bounds, mean,std, etc.) of the distribution are related with the list of TEG margins from RAN4.

Further more, Timing error margins is modeled as Truncated Gaussian distribution.

The measurement result would be a value of the list {Tc1, Tc2, . . . Tcx}, it may be inaccurate to represent the true margin of the TEG, So the bounds could be 0 and Tcx for the truncated Gaussian distribution.

The parameters (including bound or bounds, mean,std, etc.) of the distribution are related with the list of TEG margins from RAN4.

Multiple measurement schemes From embodiment #1 can be extended for this error source.

Case 2: Errors between multiple TEGs.

When the received PRSs come from one TEG, their max timing error difference is the TEG margins, it could be ignore sometimes. But if the PRS come from different TEGs, the timing error difference would be a problem. So to model the error source as Gaussian distribution or Truncated Gaussian distribution.

The distribution parameters are related with NR-timingQuality and/or Timing error and/or timing error difference and/or timing error margins.

For truncated Gaussian distribution, due to all errors are equal or baggier than zero. Other ways, the max error between different TEGs could be got from RAN4. It may be also a margin for the error distribution.

The measurement result would be a value of the list {Tc1, Tc2, . . . Tcx}, and for two TEGs, the difference from these two TEG margins result is in [0 Tcx-Tc1]. For a target device, it may receive PRS from different TEGs. So based on the TEG/TEG margin error source, it could be modeled as Gaussian distribution or Truncated Gaussian distribution. The bounds could be 0 and/or Tcx-Tc1.

It may be inaccurate to represent the true margin of the TEG, So the bounds could be 0 and Tcx for the truncated Gaussian distribution.

The parameters (including bound or bounds, mean,std, etc.) of the distribution are related with the list of TEG margins from RAN4.

Multiple measurement schemes From embodiment #1 can be extended for this error source.

Case 3: Timing error margins is related to error source parameters.

For this case, timing error is an error source which is modeled Gaussian distribution or Truncated Gaussian distribution, and the margin is measured for the parameters of the distribution. The margin is related with the parameters of the distribution. For example, based on the 3-sigma rule of Gaussian distribution, the standard deviation and the mean could be obtain referencing the margins. And the TEG margin measurement result is an up bound for the timing error source.

In some embodiments, a model for an error source can be a Gaussian distribution or truncated Gaussian distribution with parameters of distribution inlcuding the mean, the standard deviation or variance, bound or bounds.

Some additional notes include the following:
1. The relationship between multiple measurement results and location integrity parameters Schemes from Example 1 and Example 3.
2. Timing based error:
   RSTD measurement is an error source for DL-TDOA.
   RTOA measurement is an error source for UL-TDOA.
   UE Rx−Tx time difference measurement is an error source for Multi-RTT
   gNB Rx−Tx time difference measurement is an error source for Multi-RTT.
   These error sources can be modeled as Gaussian distribution or truncated Gaussian distribution.

TEG margin is an error source. Gaussian distribution or truncated Gaussian distribution.
3. Angle based error sources:

AngleQuality is taken as the measurement of angle. The measurement for integrity error source should be used for AOA and/or AOD or other angle based positioning methods.
4. Beam error:

TRP-BeamAntennaInfo is an error source. Gaussian distribution or truncated Gaussian distribution.

DL-PRS-BeamInfo is an error source. Gaussian distribution or truncated Gaussian distribution.

Field Descriptions:

dl-PRS-ID: This field specifies the DL-PRS ID of the TRP for which the Beam Antenna Information is provided.

nr-PhysCellID: This field specifies the physical Cell-ID of the TRP for which the Beam Antenna Information is provided, as defined in TS 38.331 [35].

nr-CellGlobalID: This field specifies the NCGI, the globally unique identity of a cell in NR, of the TRP for which the Beam Antenna Information is provided, as defined in TS 38.331 [35].

nr-ARFCN: This field specifies the NR-ARFCN of the TRP's CD-SSB (as defined in TS 38.300 [47]) corresponding to nr-PhysCellID.

associated-DL-PRS-ID: This field specifies the dl-PRS-ID of the associated TRP from which the beam antenna information is obtained. See the field descriptions for nr-TRP-BeamAntennaAngles and lcs-GCS-TranslationParameter.

lcs-GCS-TranslationParameter: This field provides the angles α (bearing angle), β (downtilt angle) and γ (slant angle) for the translation of a Local Coordinate System (LCS) to a Global Coordinate System (GCS) as defined in TR 38.901 [44]. If this field and the associated-DL-PRS-ID field are both absent, the azimuth and elevation are provided in a GCS. If this field is absent and the associated-DL-PRS-ID field is present, then the lcs-GCS-TranslationParameter for this TRP is obtained from the lcs-GCS-TranslationParameter of the associated TRP.

nr-TRP-BeamAntennaAngles: This field provides the relative power between DL-PRS Resources per angle per TRP. If this field is absent and the field associated-DL-PRS-ID is present, the nr-TRP-BeamAntennaAngles for this TRP are obtained from the nr-TRP-BeamAntennaAngles of the associated TRP.

Azimuth: This field specifies the azimuth angle for which the relative power between DL-PRS Resources is provided. For a Global Coordinate System (GCS), the azimuth angle is measured counter-clockwise from geographical North. For a Local Coordinate System (LCS), the azimuth angle is measured counter-clockwise from the x-axis of the LCS. Scale factor 1 degree; range 0 to 359 degrees.

azimuth-fine: This field provides finer granularity for the azimuth.

The total azimuth angle is given by azimuth+azimuth-fine. Scale factor 0.1 degrees; range 0 to 0.9 degrees.

elevation: This field specifies the elevation angle for which the relative power between DL-PRS Resources is provided for the given azimuth. For a Global Coordinate System (GCS), the elevation angle is measured relative to zenith and positive to the horizontal direction (elevation 0 deg. points to zenith, 90 deg to the horizon). For a Local Coordinate System (LCS), the elevation angle is measured relative to the z-axis of the LCS (elevation 0 deg. points to the z-axis, 90 deg to the x-y plane). Scale factor 1 degree; range 0 to 180 degrees.

elevation-fine: This field provides finer granularity for the elevation. The total elevation angle is given by elevation+elevation-fine. Scale factor 0.1 degrees; range 0 to 0.9 degrees.

beamPowerList: This field provides the relative power between DL-PRS Resources for the angle given by azimuth and elevation. The first BeamPowerElement in this list provides the peak power for this angle and is defined as 0 dB power; i.e., the first value is set to ‘0’ by the location server. All the remaining BeamPowerElement's in this list provide the relative DL-PRS Resource power relative to this first element in the list.

nr-dl-prs-ResourceSetID: This field specifies the DL-PRS Resource Set ID of the DL-PRS Resource for which the nr-dl-prs-RelativePower is provided. If this field is absent, the DL-PRS Resource Set ID for this instance of the beamPowerList is the same as the DL-PRS Resource Set ID of the previous instance in the beamPowerList. This field shall be included at least in the first instance of the beamPowerList.

nr-dl-prs-ResourceID: This field specifies the DL-PRS Resource for which the nr-dl-prs-RelativePower is provided.

nr-dl-prs-RelativePower: Except for the first element in beamPowerList, this field provides the relative power of the DL-PRS Resource, relative to the first element in the beamPowerList. For the first element in beamPowerList, this field provides the peak power for this angle normalised to 0 dB.

Scale factor 1 dB; range 0 . . . □30 dB.

nr-dl-prs-RelativePowerFine: This field provides finer granularity for the nr-dl-prs-RelativePower. The total relative power of the DL-PRS Resource is given by nr-dl-prs-RelativePower+nr-dl-prs-RelativePowerFine. Scale factor 0.1 dB; range 0 to □0.9 dB. NOTE: For the first element in beamPowerList, this field is not needed.

### Error Margin for TEG

The framework of UE/TRP Tx TEG is defined as below:
   Define multiple candidate timing error margin values {TE1, TE2, . . . , TEN} in the spec.
The number of candidate values (i.e., N) and the exact values of {TE1, TE2, . . . , TEN} will be decided in Perf part.
   UE/TRP selects one value M from {TE1, TE2, . . . , TEN} based on its implementation and indicate to gNB or LMF.
   For UE that supports multiple Tx TEGs (TEG #1, TEG #2, . . . ), the associated timing error margin value of each Tx TEG is M, which means the timing error difference between the transmission occasions of same or different SRS resources within the same Tx TEG is within the margin M.

The applicability of reported UE Tx TEG is limited to the transmission occasions of same or different SRS resources within the validity time defined by RAN2, e.g., based on the time stamp information.

Rx Timing Error: Result of Rx Time Delay involved in the reception of a signal before reporting measurements that are obtained from the signal. It is the uncalibrated Rx Time Delay, or the remaining delay after the UE/TRP internal calibration/compensation of the Rx Time Delay, involved in the reception of the DL-PRS/UL SRS signals. The calibration/compensation may also include the calibration/compensation of the relative time delay between different RF chains in the same UE/TRP and may also possibly consider the offset of the Rx antenna phase centre to the physical antenna centre.

TRP Tx Timing Error Group (TRP Tx TEG): Tx Timing Errors, associated with TRP transmissions on one or more DL-PRS Resources, that are within a certain margin.

Tx Time Delay: From a signal transmission perspective, the time delay from the time when the digital signal is generated at baseband to the time when the RF signal is transmitted from the Tx antenna.

Tx Timing Error: Result of Tx Time Delay involved in the transmission of a signal. It is the uncalibrated Tx Time Delay, or the remaining delay after the TRP/UE internal calibration/compensation of the Tx Time Delay, involved in the transmission of the DL-PRS/UL SRS signals. The calibration/compensation may also include the calibration/compensation of the relative time delay between different RF chains in the same TRP/UE and may also possibly consider the offset of the Tx antenna phase centre to the physical antenna centre.

UE Rx Timing Error Group (UE Rx TEG): Rx Timing Errors, associated with UE reporting of one or more DL measurements, that are within a certain margin.

UE RxTx Timing Error Group (UE RxTx TEG): Rx Timing Errors and Tx Timing Errors, associated with UE reporting of one or more UE Rx−Tx time difference measurements, which have the ‘Rx Timing Errors+Tx Timing Errors’ differences within a certain margin.

UE Tx Timing Error Group (UE Tx TEG): Tx Timing Errors, associated with UE transmissions on one or more UL SRS resources for positioning purpose, that are within a certain margin.

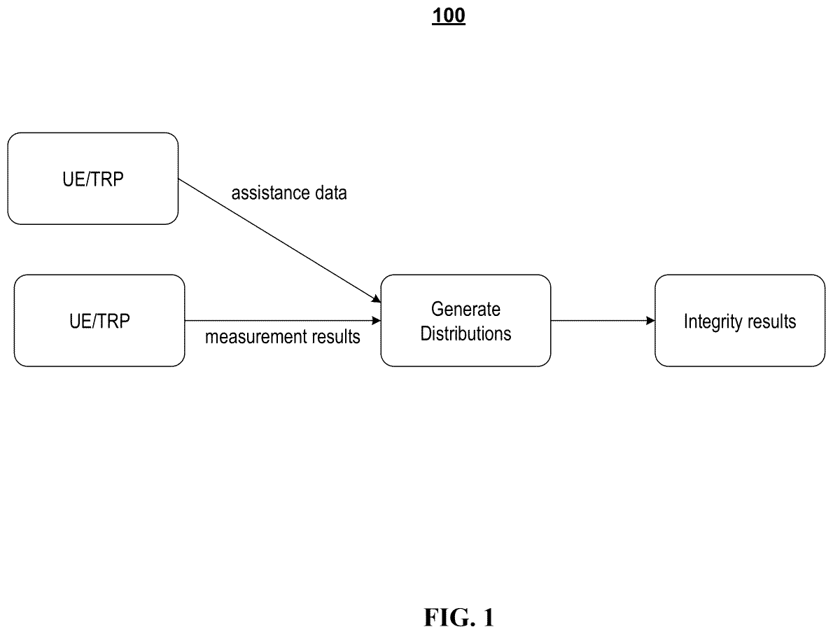

FIG. 1 depicts an example of information exchange for determining the integrity of position or location information. FIG. 1 shows a wireless device (or UE) or a TRP sending location or position measurement results and assistance data to a device that generates statistical distributions of the received location or position measurement results and the assistance data. The device generating the statistical distributions can be a network node or a wireless device (UE). From the distributions of the location or position measurement results and the assistance data, an integrity of the location or position can be determined.

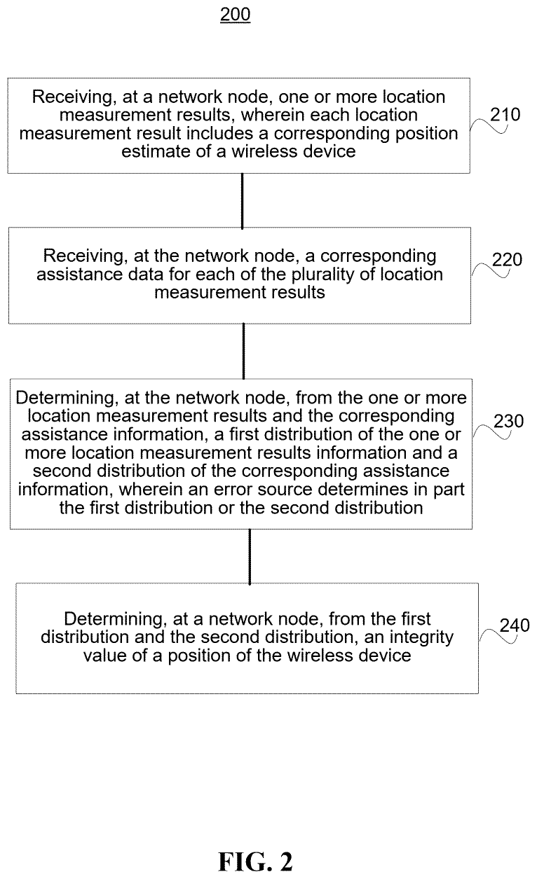

FIG. 2 depicts an example of a method of wireless communication performed at a network node. At 210, the method includes receiving, at a network node, one or more location measurement results, wherein each location measurement result includes a corresponding position estimate of a wireless device. At 220, the method includes receiving, at the network node, a corresponding assistance data for each of the plurality of location measurement results. At 230, the method includes determining, at the network node, from the one or more location measurement results and the corresponding assistance information, a first distribution of the one or more location measurement results information and a second distribution of the corresponding assistance information, wherein an error source determines in part the first distribution or the second distribution. At 240, the method includes determining, at a network node, from the first distribution and the second distribution, an integrity value of a position of the wireless device.

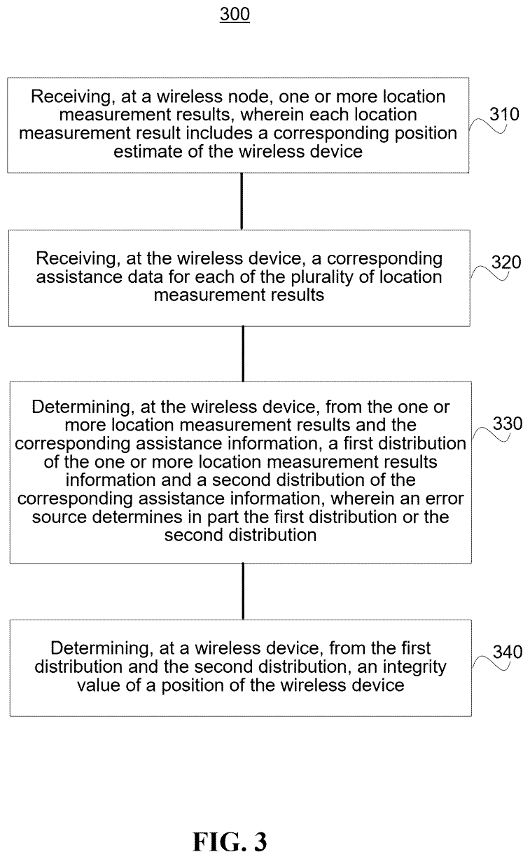

FIG. 3 depicts an example of a method of wireless communication performed at a wireless device. At 310, the method includes receiving, at a wireless node, one or more location measurement results, wherein each location measurement result includes a corresponding position estimate of the wireless device. At 320, the method includes receiving, at the wireless device, a corresponding assistance data for each of the plurality of location measurement results. At 330, the method includes determining, at the wireless device, from the one or more location measurement results and the corresponding assistance information, a first distribution of the one or more location measurement results information and a second distribution of the corresponding assistance information, wherein an error source determines in part the first distribution or the second distribution. At 340, the method includes determining, at a wireless device, from the first distribution and the second distribution, an integrity value of a position of the wireless device.

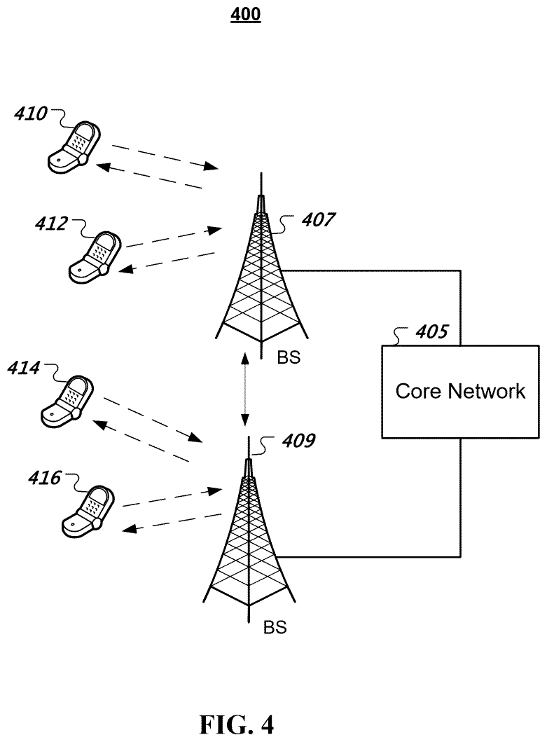

FIG. 4 shows an example of a wireless communication system (e.g., a 5G or NR cellular network) that includes one or more base stations 407, 409 and one or more user equipment (UE) 410, 412, 414 and 416. In some embodiments, the UEs access the BS and core network 405 (e.g., the network) using a communication link to the network (sometimes called uplink direction, as depicted by dashed arrows pointing toward a base station), which then enables subsequent communication. In some embodiments, the BS sends information to the UEs (sometimes called downlink direction, as depicted by arrows from the base stations to the UEs), which then enables subsequent communication between the UEs and the BSs, shown by dashed arrows between the UEs and the BSs.

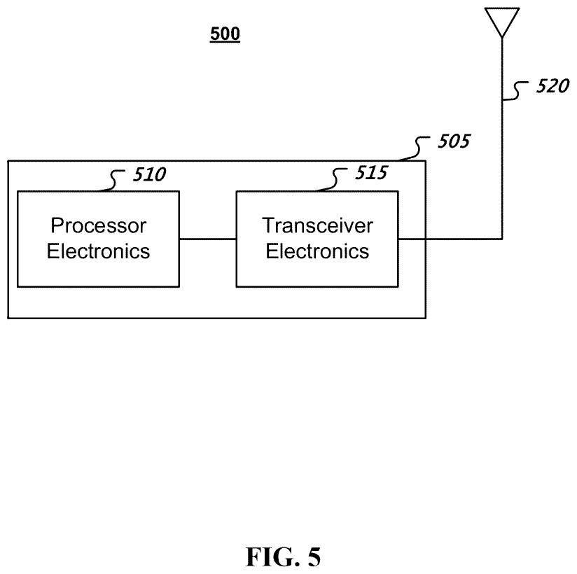

FIG. 5 shows an exemplary block diagram of a hardware platform 500 that may be a part of a network node (e.g., base station) or a communication device (e.g., a wireless device such as a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4 in the various embodiments described in this patent document. The transceiver 515 transmits or sends information or data to another device. For example, a wireless device transmitter as part of transceiver 515 can send a message to a user equipment via antenna 520. The transceiver 515 receives information or data transmitted or sent by another device via antenna 520. For example, a wireless device receiver as part of transceiver 515 can receive a message from a network device via antenna 520.

### The Following Clauses Reflect Features of Some Preferred Embodiments

Clause 1. A method of wireless communication, comprising: receiving, at a network node, one or more location measurement results, wherein each location measurement result includes a corresponding position estimate of a wireless device; receiving, at the network node, a corresponding assistance data for each of the one or more location measurement results; determining, at the network node, from the one or more location measurement results and a corresponding assistance information, a first distribution of the one or more location measurement results information and a second distribution of the corresponding assistance information, wherein an error source determines in part the first distribution or the second distribution; and determining, at a network node, from the first distribution and the second distribution, an integrity value of a position of the wireless device.
Clause 2. The method of claim 1, wherein each of the one or more location measurement results and the corresponding assistance data correspond to a different transmission reception point (TRP).
Clause 3. The method of claim 1, wherein each of the one or more location measurement results and the corresponding assistance data correspond different measurements from one TRP instance taken at different times, from different TRPs taken at different times, or from different TRPs taken at a same time.
Clause 4. The method of claim 1, wherein each of the one or more location measurement results information and the corresponding assistance data correspond to different measurement times from a same transmission reception point (TRP).
Clause 5. The method of claim 1, further comprising: determining, for each of the one or more location measurement results information and the corresponding assistance information, a corresponding integrity of the corresponding position estimate.
Clause 6. The method of claim 1, wherein, position estimate is determined by a radio access technology (RAT) dependent positioning method.
Clause 7. The method of claim 1, wherein location measurement results information is based on time-of arrival (TOA) measurements.
Clause 8. The method of claim 7, wherein the error source is associated with the TOA measurements for timing-based positioning include one or more of: a reference signal time difference (RSTD) measurement; a relative time of arrival (RTOA) measurement; a wireless device receive-transmit time difference measurement for multi-cell round trip time (multi-RTT); a network node receive-transmit time difference measurement for multi-RTT; a timing error group (TEG); or a TEG margin.
Clause 9. The method of claim 1, wherein one or more of the first distribution or the second distribution is a Gaussian distribution or a truncated Gaussian distribution.
Clause 10. The method of claim 1, wherein a quantity of location measurement results information corresponding to the one or more location measurement results information is a configurable quantity.
Clause 11. The method of claim 1, further comprising: determining one or more characteristics of the error source or one or more of the location measurement results, the one or more characteristics comprising: a maximum value; a mean value; a mode value; a median value; a minimum value; or a standard deviation value.
Clause 12. The method of claim 1, wherein statistics of the error source affect the integrity value.
Clause 13. The method of claim 1, wherein the error source is time based, angle based, or beam based.
Clause 14. The method of claim 1, wherein the one or more location measurement results are related to one another via an expected value or an uncertainty value of the first distribution or the second distribution.
Clause 15. The method of claim 13, wherein the angle-based error source includes an angle quality value.
Clause 16. The method of claim 13, wherein the angle-based error source includes a timing quality value.
Clause 17. A method of wireless communication, comprising: receiving, at a wireless node, one or more location measurement results, wherein each location measurement result includes a corresponding position estimate of the wireless device; receiving, at the wireless device, a corresponding assistance data for each of the plurality of location measurement results; determining, at the wireless device, from the one or more location measurement results and the corresponding assistance information, a first distribution of the one or more location measurement results information and a second distribution of the corresponding assistance information, wherein an error source determines in part the first distribution or the second distribution; and determining, at a wireless device, from the first distribution and the second distribution, an integrity value of a position of the wireless device.
Clause 18. An apparatus comprising a processor configured to perform any one or more of claims 1 to 17.
Clause 19. A computer-readable medium including instructions that when executed by a processor perform a method recited in any one or more of claims 1 to 17.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of wireless communication, comprising:
transmitting, by a wireless device, one or more location measurement results, wherein each location measurement result includes a corresponding position estimate of the wireless device;
transmitting, by the wireless device, a corresponding assistance data for each of the one or more location measurement results;
determining, by the wireless device, from the one or more location measurement results and a corresponding assistance information, a first distribution of the one or more location measurement results and a second distribution of the corresponding assistance information, wherein an error source determines in part the first distribution or the second distribution; and
determining, by the wireless device, from the first distribution and the second distribution, an integrity value of a position of the wireless device.

2. The method of claim 1, wherein each of the one or more location measurement results and the corresponding assistance data correspond to a different transmission reception point (TRP).

3. The method of claim 1, wherein each of the one or more location measurement results and the corresponding assistance data correspond to different measurements from one transmission reception point (TRP) instance taken at different times, from different TRPs taken at different times, or from different TRPs taken at a same time.

4. The method of claim 1, wherein each of the one or more location measurement results and the corresponding assistance data correspond to different measurement times from a same transmission reception point (TRP).

5. The method of claim 1, further comprising:
determining, for each of the one or more location measurement results and the corresponding assistance information, a corresponding integrity of the corresponding position estimate.

6. The method of claim 1, wherein a position estimate is determined by a radio access technology (RAT)-dependent positioning method.

7. The method of claim 1, wherein a location measurement result is based on a time-of arrival (TOA) measurement.

8. The method of claim 7, wherein an error source associated with the TOA measurement for a timing-based positioning includes one or more of:
a reference signal time difference (RSTD) measurement;
a relative time of arrival (RTOA) measurement;
a wireless device receive-transmit time difference measurement for multi-cell round trip time (multi-RTT);
a network node receive-transmit time difference measurement for multi-RTT;
a timing error group (TEG); or a TEG margin.

9. The method of claim 1, wherein one or more of the first distribution or the second distribution is a Gaussian distribution or a truncated Gaussian distribution.

10. The method of claim 1, wherein a quantity of location measurement results corresponding to the one or more location measurement results is a configurable quantity.

11. The method of claim 1, further comprising:
determining one or more characteristics of the error source or the one or more location measurement results, the one or more characteristics comprising:
a maximum value;
a mean value;
a mode value;
a median value;
a minimum value; or
a standard deviation value.

12. The method of claim 1, wherein statistics of the error source affect the integrity value.

13. The method of claim 1, wherein the error source is time-based, angle-based, or beam-based.

14. The method of claim 13, wherein the angle-based error source includes an angle quality value.

15. The method of claim 13, wherein the angle-based error source includes a timing quality value.

16. The method of claim 1, wherein the one or more location measurement results are related to one another via an expected value or an uncertainty value of the first distribution or the second distribution.

17. A method of wireless communication, comprising:
receiving, by a network device, one or more location measurement results, wherein each location measurement result includes a corresponding position estimate of a wireless device;
receiving, by the network device, a corresponding assistance data for each of the one or more location measurement results;
determining, by the network device, from the one or more location measurement results and a corresponding assistance information, a first distribution of the one or more location measurement results and a second distribution of the corresponding assistance information, wherein an error source determines in part the first distribution or the second distribution; and
determining, by the network device, from the first distribution and the second distribution, an integrity value of a position of the wireless device.

18. The method of claim 17, further comprising:
determining, for each of the one or more location measurement results and the corresponding assistance information, a corresponding integrity of the corresponding position estimate.

19. The method of claim 17, further comprising:
determining one or more characteristics of the error source or the one or more location measurement results, the one or more characteristics comprising:
a maximum value;
a mean value;
a mode value;
a median value;
a minimum value; or
a standard deviation value.

20. An apparatus for wireless communication, comprising a memory and at least one processor, wherein the at least one processor is configured to read code from the memory and cause the apparatus to implement a method of wireless communication, the method comprising:
transmitting, by the apparatus, one or more location measurement results, wherein each location measurement result includes a corresponding position estimate of the apparatus;
transmitting, by the apparatus, a corresponding assistance data for each of the one or more location measurement results;
determining, by the apparatus, from the one or more location measurement results and a corresponding assistance information, a first distribution of the one or more location measurement results and a second distribution of the corresponding assistance information, wherein an error source determines in part the first distribution or the second distribution; and
determining, by the apparatus, from the first distribution and the second distribution, an integrity value of a position of the apparatus.
